(19) United States
(12) Patent Application Publication
(10) Pub. No.: US 2014/0249011 A1
(43) Pub. Date: Sep. 4, 2014

(54) Method and System for Purifying Pyrolysis Oil

(71) Applicant: GEA Mechanical Equipment GmbH, Oelde (DE)

(72) Inventors: Martin Mense, Oelde (DE); Nick Fernkorn, Beckum (DE); Sascha Westerwalbesloh, Oelde (DE); Juergen Mackel, Oelde (DE)

(73) Assignee: GEA Mechanical Equipment GmbH, Oelde (DE)

(21) Appl. No.: 14/122,730

(22) PCT Filed: May 18, 2012
(86) PCT No.: PCT/EP2012/059252

§ 371 Date: Feb. 27, 2014

(30) Foreign Application Priority Data
May 30, 2011 (EP) 11168085.6

(51) Int. Cl. B04B 15/02; C10L 1/02

(52) U.S. Cl. CPC B04B 15/02; C10L 1/02
USPC 494/13; 494/37

(57) ABSTRACT

A method for clarifying pyrolysis oil includes at least the following steps: (a) at least clarifying the pyrolysis oil in a centrifuge; and (b) before and/or during the clarification according to step (a), heating the pyrolysis oil in order to reduce the viscosity of the pyrolysis oil. A system is provided for clarifying pyrolysis oil according to the method.

### BACKGROUND AND SUMMARY OF THE INVENTION

The present invention relates to a process and a plant for clarifying pyrolysis oil.

Pyrolysis oil can be obtained from biomass by destructive distillation. In the pyrolysis, the biomass is destructively distilled into solid, liquid and gaseous components. The liquid components are generally condensed at room temperature and ambient pressure and thus form pyrolysis oil. If the pyrolysis oil is to be used as fuel, it is advantageous to free the pyrolysis oil of abrasive solids to the greatest possible extent beforehand.

Owing to the materials properties inherent in the pyrolysis oil, processing using conventional centrifugal separator systems as are employed, inter alia, in the processing of heavy oil or heating oil is not possible. Thus, pyrolysis oil has, in contrast to heating oil, a high proportion of aggressive carboxylic acids, and has no lubricating capability.

U.S. Pat. No. 4,894,140 A1 discloses a process in which an oil is heated stepwise in a reactor. Here, various fractions such as petroleum spirit, which is separated off from the oil using a separation or condensation device, are given off as gases at increasing temperatures. Such a process cannot be used for clarifying a pyrolysis oil by removal of solids.

It is an object of the invention to provide a process and a plant by which the solids content of this specific product is reduced so that it is suitable for use as fuel, in particular in internal combustion engines having appropriate injection systems.

The invention achieves this object by providing a process for clarifying pyrolysis oil, and a plant for doing so, wherein the process has at least the following steps: (a) at least clarifying the pyrolysis oil in a centrifuge; and (b) heating of the pyrolysis oil, before and/or during clarification according to step (a), in order to reduce the viscosity of the pyrolysis oil.

According to the invention, a process for clarifying pyrolysis oil has at least the following steps:
a) at least one clarification of the pyrolysis oil in at least one centrifuge; and
b) heating of the pyrolysis oil, before and/or during clarification according to step a), in order to reduce the viscosity of the pyrolysis oil.

Reducing the viscosity of the pyrolysis oil, which is highly viscous at room temperature, makes centrifugal clarification of the product pyrolysis oil possible, as a result of which the pyrolysis oil can be used, for example, as fuel in internal combustion engines. In the course of clarification, solids, in particular, are separated from the liquid. It is not a case of separating off a gas.

The clarification of the pyrolysis oil is advantageously carried out in a separator, in particular a two-phase clarification separator or a two-phase nozzle separator (for removal of solids by means of the nozzles and for discharge of the clarified liquid by means of, for example, a skinning plate). This can be used in a single-stage clarification of the pyrolysis oil or be utilized in a two-stage clarification for after-clarification after a preceding clarification.

It is advantageous for the heating of the pyrolysis oil in step b) to be carried out in a temperature-regulated manner since the pyrolysis oil is heat-sensitive and tends to polymerize and decompose thermally at elevated temperatures.

Thermal decomposition of the pyrolysis oil to any great extent can advantageously be avoided as long as the pyrolysis oil is heated to a temperature of less than 70° C. However, to ensure sufficient reduction of the viscosity, it is advantageous for the pyrolysis oil to be heated to a temperature in the range 40-70° C.

When the pyrolysis oil is heated for a relatively long time, polymerization reactions can occur to an increasing extent. This would increase the viscosity of the pyrolysis oil again, which is disadvantageous. Heating to a temperature in the range 55-60° C. is therefore particularly preferred.

Both thermal decomposition and, for example, polymerization can be largely prevented as long as cooling of the pyrolysis oil is carried out shortly after clarification of the pyrolysis oil. Here, it is advantageous for a temperature decrease of 15-30 K to be effected in a time of less than 10 minutes during cooling.

It is advantageous for cooling of the pyrolysis oil to be carried out in such a way that the temperature of the pyrolysis oil is less than 40° C. after 10 minutes after clarification of the pyrolysis oil according to step a), so that after this time has elapsed undesirable heat-induced secondary reactions in the pyrolysis oil occur only to a greatly limited extent.

Overall, the residence time of the product (or a product volume unit: e.g. one litre) in the process, i.e. the time until the maximum temperature is attained during heating through clarification to recooling of the product to preferably less than 40°, should preferably be shorter than 20 minutes.

It is particularly advantageous for cooling to occur with exchange of a quantity of heat Q₁ between the pyrolysis oil after clarification according to step a) and the pyrolysis oil before heating according to step b). This gives better utilization of the heat supplied to the process. The process can thus operate in a more energy-efficient manner.

The clarification of the pyrolysis oil can be carried out in one or more stages. However, a satisfactory result is obtained in single-stage clarification only in the case of pyrolysis oil having a low proportion of solids. However, in order to ensure constantly good clarification even in the case of pyrolysis oil having an elevated solids content, it is advantageous for the clarification according to step a) to be carried out in a plurality of stages using at least one first centrifuge for preclarification and at least one second centrifuge for after-clarification.

As an alternative, the process can also be configured so that the first centrifuge for preclarification is brought into operation as a function of the solids content of the pyrolysis oil. When, on the other hand, the solids content of the pyrolysis oil is only low, a single-stage clarification by use of the second centrifuge for after-clarification can advantageously be carried out, with the first centrifuge being, for example, bypassed via a bypass line.

The preclarification of the pyrolysis oil can be carried out by use of a clarifying decanter, in particular a two-phase clarifying decanter, or a nozzle separator, in particular, a two-phase nozzle separator, and the after-clarification of the pyrolysis oil can be carried out by use of a separator, in particular a two-phase clarification separator, or a nozzle separator, in particular a two-phase nozzle separator.

To heat the pyrolysis oil according to step b), a heat source should be made of a material resistant to pyrolysis oil, at least in the segments in contact with the product. Here, heating can advantageously be carried out by way of a plate heat exchanger, a shell-and-tube heat exchanger or an electric preheater. These heat sources allow the temperature or the surface power to be limited in order to avoid unacceptably high film temperatures. Of course, heating can advantageously also be carried out stepwise by utilization of a plurality of the above-mentioned heat sources in succession, with the temperature of the pyrolysis oil being able to approach a predetermined set value stepwise.

To avoid unacceptably high film temperatures, the heating medium temperature for the heat exchangers should preferably be less than 100° C. or the surface power of electric preheaters should be less than 0.8 W/cm².

The heating of the pyrolysis oil according to step b) is advantageously followed by measurement of an actual value of a first process parameter and clarification of the pyrolysis oil if a prescribed value of the first process parameter is exceeded. Here, malfunctions in the operation of the downstream centrifuge if the viscosity of the pyrolysis oil is not yet satisfactory for clarification are avoided.

The temperature of the pyrolysis oil, the viscosity of the pyrolysis oil, the density of the pyrolysis oil and/or process parameters which can be derived therefrom can be utilized as first process parameters.

It is advantageous for recirculation to a tank containing unclarified pyrolysis oil to be carried out if the prescribed value of the first process parameter is not exceeded. In this way, the pyrolysis oil which has already been partly heated is advantageously utilized in energy terms in order to heat the pyrolysis oil present in the tank.

The pyrolysis oil can be discharged from the process into a stock tank as a function of a second process parameter. The second process parameter is preferably the fill level in the stock tank. As a result, the continuous work-up process is not interrupted in the case of a full stock tank and shutdown and start-up of the plant due to the fill level is advantageously avoided.

According to the invention, a plant for clarifying pyrolysis oil has at least one heating system for heating pyrolysis oil and at least one centrifuge for clarifying pyrolysis oil, which are connected to one another via one or more lines. The combination of heating and subsequent centrifugation makes the clarification of pyrolysis oil and its use as fuel possible.

Reliable and comprehensive clarification of pyrolysis oil is preferably carried out using at least one separator, in particular a two-phase clarification separator or a two-phase nozzle separator.

The centrifuge is advantageously configured so that it withstands the typical properties of the pyrolysis oil. This relates to not only the high viscosity but, inter alia, also the strong tendency for corrosion to occur and the lack of lubricating capability of pyrolysis oil. For corrosion during prolonged use to be advantageously avoided, it is advantageous for the centrifuge to have an interior wall and/or parts which come into contact with the product made of a particularly corrosion-resistant steel, in particular Superduplex, preferably with a PRE index (Pitting Resistant Equivalent index: describes the pit corrosion behaviour on the basis of defined alloy constituents) of greater than 40. In addition, it is advantageous for the centrifuge to have seals which come into contact with product comprising or in particular consisting of at least one polyfluorinated material and/or a polyamide and/or a perfluoro rubber.

To counter the decomposition and polymerization tendency at elevated temperatures, it is advantageous for the plant to have a cooling system for cooling pyrolysis oil after clarification in the centrifuge.

It is advantageous for the plant to have a tank for unclarified pyrolysis oil, a stock tank for clarified pyrolysis oil and a tank for a fuel or a flushing medium. The latter tank makes it possible to introduce a flushing medium, preferably for a discontinuous cleaning process.

The tanks can alternatively also be arranged outside the plant.

Likewise for a cleaning process, the plant has, in particular on the lines, flushing connections for sequential flooding of the plant with the flushing medium. In this way, for example, individual regions of the plant can be cleaned.

### BRIEF DESCRIPTION OF THE DRAWING

In the following, a working example of the invention is described in more detail with the aid of the attached figure, FIG. 1.

FIG. 1 schematically shows a plant for clarifying pyrolysis oil.

### DETAILED DESCRIPTION OF THE DRAWING

To give a better understanding of the physical and chemical properties of pyrolysis oil, a pyrolysis oil will be characterized in more detail below in terms of the joule value, the density, the viscosity and the solids content. Here, the values indicated are merely illustrative for a pyrolysis oil. Of course, oils which are not encompassed by the numerical ranges given below but have similar properties also come under the definition of a pyrolysis oil.

Pyrolysis oil which can be produced, inter alia, from biomass is used, inter alia, as biofuel because of its joule value of about 15-18 MJ/kg. The pyrolysis oil after it has been obtained has a highly viscous, syrup-like consistency and has, for example, a viscosity in the region of 173.4 cSt and a density in the region of 1.211 g/ml, measured at 23° C. In addition, pyrolysis oil has a pH of 2.5-3.5. This low pH is caused by aggressive carboxylic acids, in particular formic acid or acetic acid, in the pyrolysis oil. At the same time, pyrolysis oil has a solids content of up to 25% by volume, but usually 0.1-20% by volume.

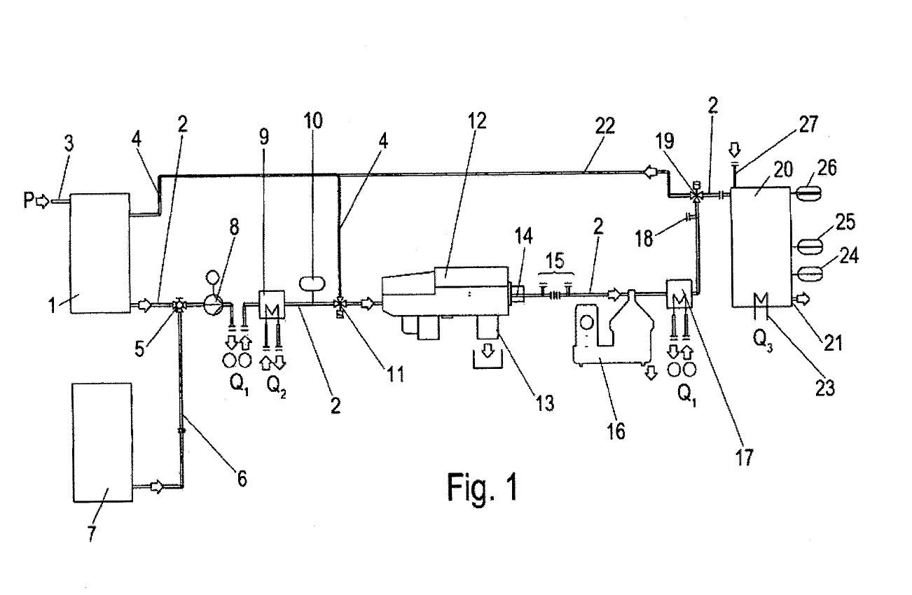

To achieve clarification of a pyrolysis oil, the plant shown in FIG. 1, which operates according to a preferred variant of the process of the invention, is used.

After it has been obtained, the pyrolysis oil is stored at preferably 20-25° C. in a tank 1. Storage is particularly preferably effected under a nitrogen atmosphere. The tank 1 has, in addition to the nitrogen feed line which is not shown in more detail, a number of lines. A first line 2 serves to discharge pyrolysis oil from the tank 1. A second line 3 serves to feed pyrolysis oil from the production process into the tank 1. A third line 4 serves to recirculate product from the process circuit.

Pyrolysis oil is conveyed from the tank 1 by a feed pump 8. A 3/2-way switching valve 5 is arranged in the first line 2 upstream of the feed pump 8. Standby fuel or a flushing medium from a storage tank 7 can be additionally introduced into the remaining plant via this 3/2-way switching valve. A fourth line 6, which connects the remaining plant to storage tank 7, branches off from the first line 2 at the 3/2-way switching valve. The feed pump 8 conveys, depending on the setting of the 3/2-way switching valve, the said fuel or the flushing medium from the storage tank 7 or the pyrolysis oil from the tank 1. The feed pump 8 is advantageously configured as a centrifugal pump and is selected with a view to the materials properties of the pyrolysis oil.

The pyrolysis oil is subsequently conveyed through a first preheater, here through a heat exchanger. In this, a quantity of heat Q₁ is transferred by way of the heat exchanger to the pyrolysis oil. The pyrolysis oil is subsequently conveyed through a second preheater 9, which transfers the quantity of heat Q₂ to the pyrolysis oil. As heat exchangers, preference is given to using plate heat exchangers or shell-and-tube heat exchangers. Preference is given to using plate heat exchangers, shell-and-tube heat exchangers or electric preheaters as second preheater 9. The pyrolysis oil is heated to a temperature of 40-70° C., preferably 55-60° C., by the preheaters.

The flow of pyrolysis oil through the first line 2 is subsequently determined by a flow meter 10. This can be effected, for example, by determining the volume flow of pyrolysis oil which passes a particular section of the first line 2 in a particular time.

The measured volume flow of the pyrolysis oil at the temperature set by use of the two preheaters corresponds to the work-up feed rate.

Downstream of the flow meter, there is a 3/2-way feed valve 11 in the first line 2, with the third line 4 for product recirculation branching off from the first line 2 at this 3/2-way feed valve 11. This 3/2-way feed valve switches over to the third line 4 for product recirculation to the tank 1 until the pyrolysis oil has been heated to a predetermined temperature by the preheaters. In the case of system malfunctions or a discontinuous self-cleaning cycle of a downstream machine, in particular a downstream two-phase clarification separator 16, too, the 3/2-way feed valve 11 switches over to the third line 4 and allows recirculation of the pyrolysis oil to the tank 1.

When the pyrolysis oil has reached the appropriate process temperature as a result of the preheaters 17 and 9, it is passed on to a two-phase decanter 12. Here, the pyrolysis oil is preclarified to give a sludge, which is discharged through the solids discharge 13 on the two-phase decanter 12, and a preclarified pyrolysis oil, which leaves the decanter 12 through a liquid discharge line 14. The liquid discharge line opens into the first line 2, which conveys the preclarified pyrolysis oil from the two-phase clarifying decanter 12 to a self-cleaning two-phase clarification separator 16. The after-clarification of the preclarified pyrolysis oil to give a clarified pyrolysis oil and a separator sludge occurs here.

The clarified pyrolysis oil is subsequently cooled. This is preferably carried out in the heat exchanger 17 by transfer of the quantity of heat Q₁ to the pyrolysis oil from the tank 1. The transfer of the quantity of heat Q₁ is shown in idealized form and naturally occurs with loss of heat to the surroundings and is therefore incomplete. The clarified pyrolysis oil is conveyed via the first line 2 from the self-cleaning two-phase clarification separator 16 to the heat exchanger 17 where it is cooled to a temperature of less than 50° C. From there, the clarified pyrolysis oil is passed on to a stock tank 20 via the first line 2.

Between the heat exchanger 17 and the stock tank 20, there is a 3-way switching valve 19. At the switching valve, a fifth line 22 branches off. This opens into the third line 4 for recirculation of product. This valve switches automatically as a function of the fill level in the stock tank 20. When the stock tank 20 can no longer accommodate any further pyrolysis oil, the 3-way switching valve 19 switches over to the line 22, so that the work-up process does not have to be interrupted for emptying the stock tank 20 by discharge of the pyrolysis oil from the discharge line 21. Shutdown and start-up of the plant is advantageously prevented thereby.

To ensure sufficient pumpability and low viscosity, for example for conveying the product further on, the stock tank 20 has a heat source 23 for introducing a quantity of heat Q₃. The plurality of fill level sensors 24-26 are arranged on the stock tank 20 to monitor the fill level. Furthermore, a nitrogen feed line 27 is arranged on the stock tank 20 in order to store the pyrolysis oil under protective gas, preferably nitrogen.

The stock tank 20 can optionally also be located outside the plant and simultaneously perform the function of a reservoir buffer vessel of a downstream fuel supply and conditioning system of internal combustion engines.

One or more flushing connections 15 and 18 are arranged along the first line 2 between the two-phase decanter 12 and the clarifying separator 16 and between the heat exchanger 17 and the 3-way switching valve 19. Since the pyrolysis oil may tend to adhere to the wall of a line, it is advisable to clean the lines from time to time.

The plant shown in FIG. 1 is based on a process with two-stage clarification of the pyrolysis oil.

In a further preferred variant of the process of the invention, the clarification of the pyrolysis oil can be carried out in a single-stage centrifugal solids/sediment removal. This is particularly the case when the pyrolysis oil has only a low solids content, preferably less than 5% by volume. It is carried out in a particularly preferred way by use of a self-cleaning two-phase clarification separator 16.

In a further preferred variant of the process of the invention, the clarification of the pyrolysis oil can be carried out either as a single-stage centrifugal solids/sediment removal or as a two-stage clarification in which a bypass line having appropriate shut-off valves is arranged in the plant depicted in FIG. 1 in such a way that the two-phase clarifying decanter is brought into operation only when necessary and, at a low solids content, the pyrolysis oil is not conveyed through the two-phase clarifying decanter but past it.

As an alternative, a two-phase nozzle separator can in principle also be used instead of the two-phase clarification separator.

The preferred variant of the process for clarifying a pyrolysis oil, as is carried out in the plant in FIG. 1, is described in detail below.

Firstly, an unclarified pyrolysis oil is fed into the plant, preferably into the tank 1, for example from an upstream production process.

The pyrolysis oil is subsequently fed into the first preheater 17. This occurs by way of a feed pump which is appropriately selected with a view to the corrosive and viscous product without lubricating properties which is to be processed. The pyrolysis oil passes the 3/2-way switching valve 5 which makes introduction of a flushing medium from the stock tank into the plant possible as an alternative to introduction of a pyrolysis oil.

After the pyrolysis oil has been introduced, it is heated to a temperature in the range 40-70° C., preferably 55-60° C., by the first preheater 17 and the second preheater 9.

After heating, the pyrolysis oil is, depending on the temperature, either introduced into the two-phase clarifying decanter or, if the temperature is not sufficient, recirculated via the third line 4 to the tank 1.

Heating is, in the present example, followed by pre-clarification by use of the two-phase clarifying decanter 12 in which the solids content is preferably reduced by at least half.

From the two-phase clarifying decanter 12, the pre-clarified pyrolysis oil is transferred to the two-phase clarification separator 16. This clarification separator makes after-clarification to a solids content of preferably less than 1% by volume possible.

Here, the parts of the two-phase clarification separator and of the two-phase clarifying decanter which come into contact with product are made of materials which are chemically resistant to the pyrolysis oil. Thus, the parts which come into contact with product and the interior wall of the respective centrifuge drum have to be made of Superduplex, preferably having a PRE index of greater than 40. As material for the seals, preference is given to using polyfluorinated materials, in particular polytetra-fluoroethylene (PTFE) or perfluoro rubber (FFR) and/or polyamide.

After the after-clarification, the clarified and heated pyrolysis oil is brought to a temperature of less than 40° C. by cooling. This largely avoids both polymerization and thermal decomposition. The unclarified still unheated pyrolysis oil from the tank 1 can be used as countercurrent in the first preheater 17, which is advantageous in energy terms.

Finally, the pyrolysis oil is transferred into a stock tank 20. The pyrolysis oil is preferably stored under protective gas, in particular under nitrogen, both in the tank 1 and in the stock tank 20.

An electric heating/supplementary heating element on the outer container wall is preferably used as heat source 23 for heating the stock tank 20. This has the advantage that a quantity of heat Q₃ to be transferred is transferred via the large surface area to the medium and local caking on surfaces and also thermal decomposition or polymerization of the pyrolysis oil are thus prevented. The product is in this way kept fluid, preferably at a temperature of less than 40° C., in order to avoid decomposition.

### LIST OF REFERENCE NUMERALS

1 Tank

2 first line

3 second line

4 third line

5 3/2-way switching valve

6 fourth line

7 Storage tank

8 Feed pump

9 Preheater

10 Flow meter

11 3/2-way feed valve

12 Two-phase clarifying decanter

13 Solids discharge line

14 Liquid discharge line

15 Flushing connection

16 Two-phase clarification separator

17 Preheater

18 Flushing connection

19 3-way switching valve

20 Stock tank

21 Discharge line

22 fifth line

23 Heat source

24 Fill level sensor

25 Fill level sensor

26 Fill level sensor

27 Nitrogen feed line

Q₁, Q₂, Q₃ Quantities of heat

1.-22. (canceled)

23. A process for clarifying pyrolysis oil, the process comprising the acts of:
(a) at least one clarification of the pyrolysis oil in a centrifuge; and
(b) before and/or during the clarification according to (a), heating the pyrolysis oil in order to reduce viscosity of the pyrolysis oil.

24. The process according to claim 23, wherein the clarification of the pyrolysis oil according to (a) is followed by cooling of the pyrolysis oil.

25. The process according to claim 23, wherein the clarification of the pyrolysis oil is carried out in a separator.

26. The process according to claim 25, wherein the separator is a two-phase clarification separator or a two-phase nozzle separator.

27. The process according to claim 23, wherein the heating of the pyrolysis oil according to (b) is carried out in a temperature-regulated manner.

28. The process according to claim 23, wherein the heating of the pyrolysis oil is carried out to a temperature of ≦70° C.

29. The process according to claim 23, wherein the heating of the pyrolysis oil is carried out to a temperature of 40-70° C.

30. The process according to claim 23, wherein the heating of the pyrolysis oil is carried out to a temperature of 55-60° C.

31. The process according to claim 24, wherein the pyrolysis oil is cooled by 15-30 Kin a time of less than 10 min.

32. The process according to claim 24, wherein the cooling of the pyrolysis oil is carried out such that the temperature of the pyrolysis oil is less than 40° C. after 10 minutes after clarification of the pyrolysis oil according to (a).

33. The process according to claim 24, wherein the cooling is carried out with exchange of a quantity of heat Q₁ between the pyrolysis oil after clarification according to (a) and the pyrolysis oil before heating according to (b).

34. The process according to claim 23, wherein the clarification of the pyrolysis oil according to (a) is carried out in a plurality of stages using at least one first centrifuge for preclarification and at least one second centrifuge for after-clarification.

35. The process according to claim 34, wherein the preclarification of the pyrolysis oil is carried out by a clarifying decanter, and wherein the after-clarification of the pyrolysis oil is carried out by a separator.

36. The process according to claim 34, wherein the first centrifuge for pre-clarification is brought into operation as a function of a solids content of the pyrolysis oil.

37. The process according to claim 23, wherein the heating of the pyrolysis oil according to (b) is carried out by a preheater.

38. The process according to claim 37, wherein the preheater is a plate heat exchanger, a shell-and-tube heat exchanger or an electric preheater.

39. The process according to claim 23, wherein an actual value of a first process parameter is measured after heating of the pyrolysis oil according to (b), and clarification of the pyrolysis oil is carried out only when a prescribed value of the first process parameter is exceeded.

40. The process according to claim 39, wherein recirculation to a tank containing unclarified pyrolysis oil is carried out when the prescribed value of the first process parameter is not exceeded.

41. The process according to claim 39, wherein the process parameters are: temperature of the pyrolysis oil, viscosity of the pyrolysis oil, density of the pyrolysis oil, and/or process parameters derivable therefrom.

42. The process according to claim 23, wherein after the pyrolysis oil has been clarified according to (a), the clarified pyrolysis oil is discharged into a stock tank as a function of a second process parameter, with the second process parameter being a fill level of the stock tank.

43. The process according to claim 23, wherein a residence time of the oil or of an oil volume unit in the process is less than 20 minutes.

44. A plant for clarifying pyrolysis oil, comprising:
a heater configured to heat the pyrolysis oil;
at least one centrifuge for clarifying the pyrolysis oil; and
one or more lines operatively configured to connect the heater and the at least one centrifuge, wherein
the plant is configured such that the heater heats the pyrolysis oil before and/or during clarification of the pyrolysis oil by the at least one centrifuge in order to reduce a viscosity of the pyrolysis oil.

45. The plant according to claim 44, wherein the at least one centrifuge is a two-phase clarification separator or a two-phase nozzle separator.

46. The plant according to claim 44, wherein the centrifuge has:
an interior wall and/or surfaces, which come into contact with the pyrolysis oil, made of Superduplex having a PRE index of greater than 40, and/or
seals, which come into contact with the pyrolysis oil, comprising at least one polyfluorinated material, polyamide and/or perfluoro rubber.

47. The plant according to claim 44, further comprising a cooler configured to cool the pyrolysis oil after clarification in the centrifuge.

48. The plant according to claim 47, wherein the plant further comprises:
a tank for storing unclarified pyrolysis oil;
a stock tank for clarified pyrolysis oil; and
a storage tank for storing a fuel or a flushing medium, the plant being configured with flushing connections that allow sequential flooding of the plant with the flushing medium.
